(19) United States
(12) Patent Application Publication
(10) Pub. No.: US 2016/0269719 A1
(43) Pub. Date: Sep. 15, 2016

(54) OPTICAL DEVICE GIVING A RAISED APPEARANCE TO AN IMAGE THAT PARTIALLY COVERS A LUMINOUS ENERGY SENSOR

(71) Applicant: SUNPARTNER TECHNOLOGIES, AIX EN PROVENCE (FR)

(72) Inventor: Olivier GAGLIANO, Aix En Provence (FR)

(73) Assignee: SUNPARTNER TECHNOLOGIES, Aix En Provence (FR)

(21) Appl. No.: 15/032,189

(22) PCT Filed: Oct. 29, 2014
(86) PCT No.: PCT/FR2014/000233

§ 371 Date: Apr. 26, 2016

(30) Foreign Application Priority Data
Oct. 31, 2013 (FR) 13 02539

(51) Int. Cl. H04N 13/04

(52) U.S. Cl. CPC H04N 13/0404; H04N 13/0422; H04N 13/0497; H04N 2213/001

(57) ABSTRACT

An optical device includes (a) a sensor of luminous energy from an external light source; (b) a transparent plate between the external light source and the sensor, having a first, front surface oriented towards the external light source and a second, rear surface oriented towards the sensor, the transparent plate being optically structured on one of the two surfaces thereof by a plurality of straight optical elements that are parallel to one another; and (c) a plurality of image strips separated by transparency strips. The longitudinal axis of the image strips is tilted by an angle (a) other than zero relative to the longitudinal axis of the optical elements of the transparent plate, such that images viewed through the transparent plate appear with a certain relief, while the energy production of the sensor remains substantially constant regardless of the angle of incidence of external light on the device.

### TECHNICAL FIELD OF THE INVENTION

The present invention relates to optical devices which give an appearance of relief to image zones placed in front of a light energy sensor.

### STATE OF THE ART

The discrete visual integration of light energy sensors such as solar sensors, typically of dark appearance, is particularly useful in objects whose main function is to serve as a screen, at least partially, to solar rays, such as, for example, in blinds, sun-shades, parasols, shading structures and the like. However, a good visual and functional integration of the solar sensors can also be useful in a wider range of supports, such as buildings, roofs, walls, tiles, glazings, transport vehicles, including boats and aeroplanes advertizing posters, watches, portable electronic display devices, clothing, backpacks and, generally, on any planer or non-planer support.

The need to visually integrate solar sensors, notably photovoltaic cells of dark or black appearance, in our environment, requires them to be covered by a color or a semi-transparent image, while reducing as little as possible the performance levels of the solar sensors. Already known, more particularly from the patents WO/2007/085721 (Sunpartner Technologies) and WO/2010/067029 (Saint-Gobain Glass), are optical devices composed of an array of rectilinear lenses and an array of image zones placed facing the lenses which allow an observer to alternately view either the image reconstructed by the lenses or the solar sensor which is placed behind the device. The viewing of the image or of the solar sensor then depends on the angle of observation relative to the optical surface. When the lenses are rectilinear and cylindrical, this alternation is repeated approximately every 25°.

One of the main limitations of this system stems from the fact that, according to the relative position of the observer in relation to the device, said observer does not continuously see the same image. In addition, a minimum distance is required between the observer and the device for all of the image zones to be fully seen. There are therefore positions of observation for which the observer sees only the sensor or a truncated image, which counters the full integration of said sensor. Finally, the external light reaches the solar sensor only for given angles of incidence, which necessitates appropriately positioning the device in relation to the trajectory of the sun. The phenomena described previously limit the applications of the known system to fixed systems for which the angular zones of observation and of production are restricted.

Another limitation of this device stems from its fabrication method, which requires an extremely accurate setting between the image zones and the array of rectilinear lenses, in particular for the alignment of the image strips in relation to the longitudinal axis of the lenses. This setting is all the more difficult to obtain when the resolution of the array of lenses, that is to say the number of lenses per unit of length, is low. In effect, there is no means other than manual for producing this alignment, which is a real brake on the marketing of such devices.

Simultaneously solving the abovementioned problems would therefore make it possible to improve the integration of the light energy sensors independently of their angular ranges of observation and to simplify the method for fabricating such a device, while keeping the proportion of the visible active surface of the sensors in relation to the total surface area of these solar sensors substantially constant regardless of the orientation of the device in relation to the light source, which also amounts to stating that, for a given orientation of the device, the electrical production of the sensor will also be constant.

The present invention aims to resolve these problems and to remedy the abovementioned drawbacks of the prior art, by proposing a novel optical device structure.

Rather than seeking to entirely mask the sensor this novel integration approach consists in making a part of its surface visible, in partially covering it with an image and in giving an illusion of three-dimensionality and/or of relief to said system, such that the sensor becomes attractive or of playful appearance for the observer.

### OBJECTS OF THE INVENTION

The subject of the invention consists of a device as defined in the claims.

The device according to the invention comprises at least:

(a) a sensor of light energy originating from an external light source;
(b) an optically structured transparent plate arranged between said external light source and said sensor, comprising a first face called “front face” which is oriented toward said external light source and a second face called “rear face” which is oriented toward said sensor, said transparent plate being structured optically on one of its two faces at least by a plurality of rectilinear and mutually parallel optical elements;
(c) a plurality of image strips separated by transparency strips;
said device is characterized in that the longitudinal axis of the image strips is inclined by a non-zero angle relative to the longitudinal axis of the optical elements of the transparent plate, such that said images seen through the transparent plate appear with an appearance of relief, while the energy production of the sensor remains substantially constant whatever the angle of incidence of said external light on the device.

According to different embodiments of the device, the total surface area of the image strips is substantially identical to the total surface area of the transparency strips.

In particular embodiments, the angle of inclination between the longitudinal axis of the lenses and the longitudinal axis of the image strips lies between 35° and 70°, such that the appearance of said images remains substantially constant as a function of the angle of observation of the device.

Said image strips are fixed or animated and consist of a multitude of opaque, reflecting or semi-transparent pixels, printed or generated electronically by backlit, light-emitting or reflecting components. Thus, by acting on the size of the zones of transparency between the image strips or on the transparency of the pixels of which they are formed, it is possible to modify the quantity of light energy likely to reach the surface of the sensor.

Said image strips can be positioned between the sensor and the rear face of the transparent plate, or downstream of said sensor, the term downstream referring to the direction of propagation of the light from the external light source toward the device.

Said image strips can also be in contact with said sensor and/or said rear face of the transparent plate, or separated from these surfaces by a material of refractive index different from that of the transparent plate. In this way, it is possible to position the image strips either directly on the rear face of the transparent plate, or on a transparent support which is then arranged against said rear face of the transparent plate. In the latter case, said transparent support can be separated from said rear face of the transparent plate and/or from said sensor either by air, or by an optical glue of refractive index close to that of the transparent plate. The first solution gives the possibility of replacing the image of the device without changing the transparent plate or the sensor while the second solution avoids the spurious reflections and the light energy losses at the interfaces.

The main applications of the invention lie in the case where the light energy sensor is a solar sensor of thermal, photovoltaic, chemical or hybrid type, planer or curved, rigid or flexible.

According to an additional variant embodiment, said light energy sensor is composed of solid or semi-transparent active zones, adjacent or separated from one another by zones of transparency.

According to the embodiments retained, the optical elements of the transparent plate are:

(a) convex or concave lenses, symmetrical or asymmetrical;
(b) prisms.

The result thereof is that the optical structuring of the transparent plate can be produced on just one of its faces or else on both, with geometrical shapes which can be identical or different.

According to different embodiments of the device, the transparent plate, the image strips and the sensor are contained in planes that are advantageously mutually parallel, but can undergo a deformation such that these planer surfaces become curved surfaces, notably in the case of a flexible device.

In a particular embodiment, the optical elements of the transparent plate and the image strips are organized in arrays of basic structures. The term basic qualifies the smallest pattern of the array which, once repeated, constitutes said array and the regular spacing between two identical points of two adjacent basic patterns defines the pitch of the array. In this way, it is possible to transform the uniform surface of the light energy sensor into a surface made up of regular patterns. The color and the form of these patterns depend simultaneously on the color of the sensor, on the form of the array of the optical elements of the transparent plate and finally on the color and on the form of the array of image strips.

According to the embodiments retained, the transparent plate and the image strips are fixed or mobile relative to the sensor, by undergoing, for example, translational and/or rotational movements.

The transparent plate consists of a solid, liquid or gaseous transparent material, such as mineral glass, organic glass, or even a polymer of PMMA, PET or polycarbonate type, and can be planer or curved, rigid or flexible, colored in its mass or colorless.

In a particular embodiment that is not represented, one of the two faces of said transparent plate at least is covered by a functional surface having an additional function other than the simple transmission of light, for example an antiglare, anti-fouling or anti-UV effect.

According to an additional variant embodiment of the device that is not represented, the image strips are illuminated by one or more sources of lighting from which most of the light is propagated in the thickness of the transparent plate which acts as waveguide, or in an additional transparent plate placed upstream or downstream of the transparent plate, the terms upstream and downstream referring to the direction of propagation of the light from the source of lighting toward the device.

In another advantageous variant of the device according to the invention, the light energy sensor is a photovoltaic sensor provided with electron-collecting gratings on the surface of said sensor, and a part of the surface of said image strips consists of the visible face of the electron-collecting gratings. In this way, the production of the device is simplified since the image zones are directly included in the sensor during its fabrication, which avoids an additional step of printing of said image zones.

According to another degraded variant of the invention, the light energy sensor is replaced by any non-functional support, of the same dark appearance as a light energy sensor. In this case, the same effect of visual integration of said support is of course obtained as in the case of a light energy sensor, but without the device producing energy.

### FIGURES The invention will be better understood using the detailed description thereof, in relation to the figures, in which:

FIGS. 1a and 1b schematically show the structure of a device according to the prior art;

FIGS. 2a, 2b and 2c schematically show the structure of a device according to the invention;

FIGS. 3a, 3b and 3c show, in plan view, the appearance of the device according to the invention according to various angles of observation and respective orientations of the transparent plate and of the image strips;

FIG. 4 schematically shows the structure of another variant embodiment of the device according to the invention;

FIGS. 5a and 5b compare the electrical production as a function of the angle of incidence of light for a device known from the prior art and for the device that is the subject of the invention.

The figures are not to scale, the relative thicknesses of the components of the device being deliberately exaggerated to better show its structure.

List of references used in the figures:

| | |
|---|---|
| 1 | Transparent plate |
| 2 | Front face of the transparent |
| | plate |
| 3 | Image strips |
| 4 | Transparency strips |
| 5 | Light energy sensor |
| 6 | Rear face of the transparent |
| | plate |
| 7 | Light beam |
| 8 | Observer |
| 9 | Transparent support |
| 10 | Visible image zone |
| 11 | Visible zone of the |
| | sensor |
| 12 | Visible array |
| 13 | Eye of the observer |
| 14 | Device according to the |
| | prior art |
| 15 | Device according to the |
| | invention |
| 16 | External light source |

### DETAILED DESCRIPTION

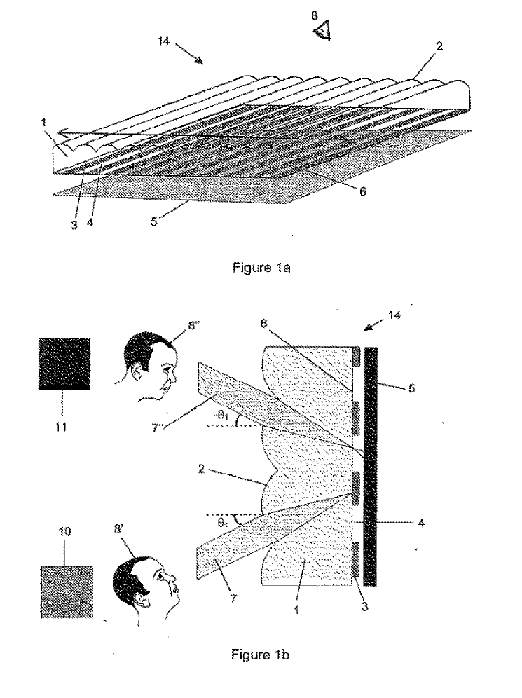

Reference is made to FIG. 1, which corresponds to a three-dimensional view (FIG. 1a) and to a view in transverse cross section (FIG. 1b) of a known device according to the patent application WO/2007/085721.

This device 14 comprises a transparent plate 1 that is optically structured and arranged between an observer 8 and a light energy sensor 5. The front face 2 of said transparent plate 1 is composed of an array of cylindrical rectilinear lenses, of planer-convex types. The planer rear face 6 contains an array of image strips 3 and of transparency strips 4. As represented in FIG. 1a, the longitudinal axis of said strips (3, 4) is parallel to the longitudinal axis of the lenses, and the pitch of the array of lenses is the same as the pitch of the array of image strips.

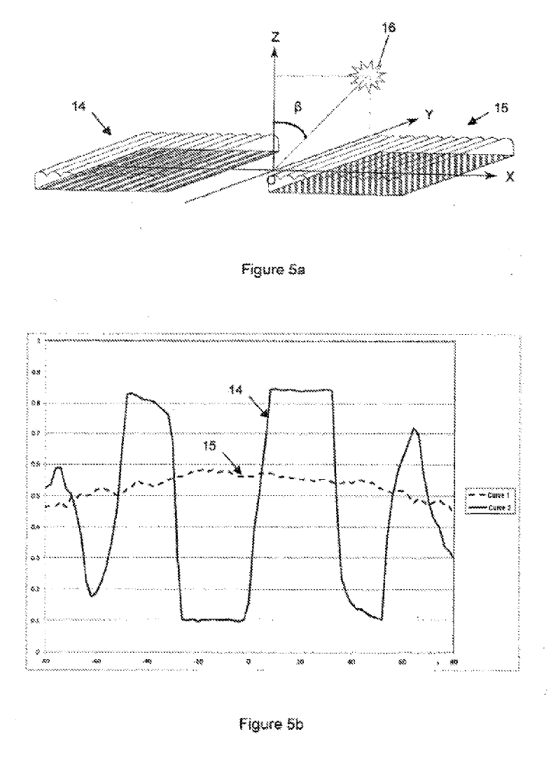

FIG. 1b is a view in transverse cross section of the device, namely a cross section on a plane which contains the straight line represented by the double-headed arrow of FIG. 1a and which is orthogonal to the longitudinal axis of the lenses of the transparent plate 1. A first observer 8′ positioned facing the device with an angle of observation θ₁ in relation to the normal to the lenses sees a light beam 7′ from an image strip 3. In this position, he or she therefore sees all of the image 10 showing, reconstituted by the set of image strips 3. By symmetry with respect to the first observer 8′, a second observer 8″ for whom the angle of observation of the device is—θ₁ sees, by contrast, the light beam 7″ which has been reflected at the surface of the sensor 5 and which passes through a zone of transparency 4 of the image. From this angle, the second observer 8″ therefore sees only the visible surface 11 of the sensor 5, generally of dark color. The known device according to FIG. 1 therefore has the drawback of a discontinuity of the ranges of vision of the image zones 3 which cover the sensor 5, and, by symmetry, of the ranges of illumination and therefore of energy production of said sensor 5, represented in FIG. 5b and explained hereinbelow.

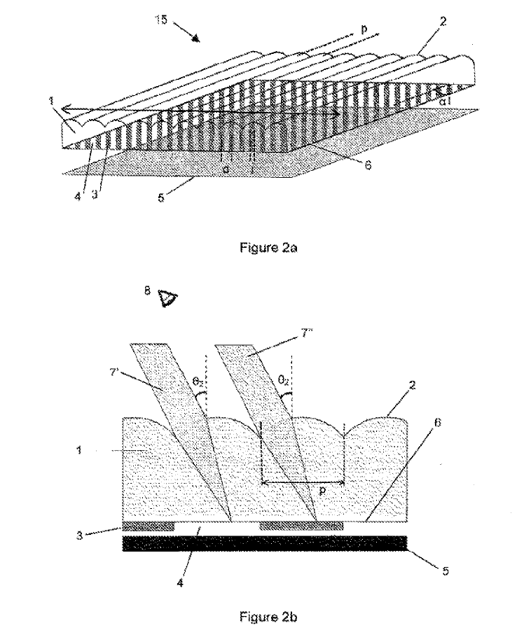

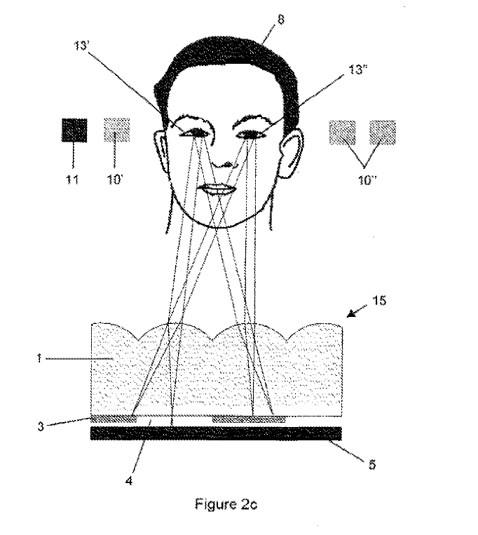

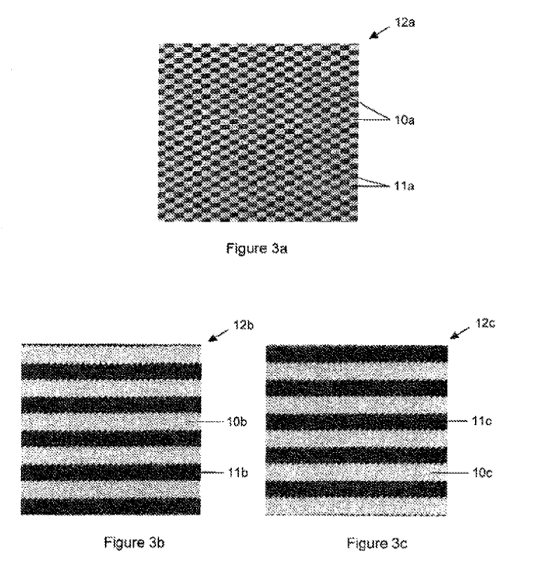

FIG. 2 illustrates a three-dimensional view (FIG. 2a) and two views in transverse cross section (FIGS. 2b and 2c) of a device according to the invention. The device consists of a sensor 5 of the light energy originating from an external light source, a plurality of image strips 3 and of transparency strips 4, and an optically structured transparent plate 1. The front face 2 of said transparent plate 1 is composed of an array of cylindrical rectilinear lenses, of planer-convex types, which advantageously have their focal plane situated in the plane of the rear face 6 of the transparent plate 1. The planer rear face 6 contains an array of image strips 3 of width 1 separated by transparency strips 4. According to the invention, the longitudinal axis of the image strips 3 is inclined by a non-zero angle α in relation to the longitudinal axis of the lenses, as represented in FIG. 2a. The arrays of lenses and of image strips 3 are defined by their pitches, respectively p and d, which represent the distance between two adjacent lenses or between two adjacent image strips 3. FIG. 2b is a view in transverse cross section of the device on a plane which contains the straight line represented by the double-headed arrow of FIG. 3a and which is orthogonal to the longitudinal axis of the lenses of the transparent plate 1. From a same angle of observation θ₂ in relation to the normal to the lenses, an observer 8 sees both light beams 7′ and 7″ reflected respectively by the sensor 5 and by the image strips 3. The device according to the invention therefore makes it possible for an observer 8, regardless of his or her angle of observation, to simultaneously see the sensor 5 and the image strips 3, which eliminates the discontinuities of visibility of the device known in the prior art corresponding to FIG. 1.

Furthermore, regardless of his or her position, the observer 8 sees, with his or her right eye 13′, different images from those perceived by his or her left eye 13″, as illustrated in FIG. 2c, which allows the brain of the observer 8 to reconstruct a three-dimensional image. For example, the right eye 13′ perceives both visible zones 11 of the sensor 5 and image zones 10′, whereas the left eye sees only image zones 10″. It is this phenomenon which gives the image covering the sensor 5 an appearance of relief.

FIG. 3 illustrates, in plan view, three particular embodiments of the device according to the invention 15 schematically represented in FIG. 2, for which the pitch d between two adjacent image strips 3 is equal to the pitch p between two adjacent rectilinear lenses, and the width 1 of the image strips 3 is equal to half the pitch p. The three illustrations correspond to different angles of observation.

As shown in FIGS. 3a, 3b and 3c, the appearance of the device seen from above changes as a function of the angle of observation θ and of the respective orientation of the transparent plate 1 and of the image strips 3, this orientation being defined by the angle of inclination α. The visual impression of the observer who sees the image strips 3 through the optically structured transparent plate 1 is called visible image zone 10. The complementary zones seen by the observer by virtue of the zones of transparency 4 are called visible zones 11 of the sensor.

For an angle of observation θ of 0° and an angle of inclination α of 60° (FIG. 3a), an illusion of inter-leafing of the visible image zones 10a and of the visible zones of the sensor 11a is obtained in the form of a visible array 12a with cubic meshing. The parameters which describe the form of said visible array 12a are directly correlated to the parameters p, d, l and α defined previously.

By keeping the same angle of observation θ of 0° and by modifying the angle of inclination α so that it is 10°, the form of the visible array changes. The resulting array 12b is illustrated in FIG. 3b. In this configuration, an illusion of the visible image strips 10b and of visible strips of the sensor 11b is obtained. These visible image strips 10b are the resultant from a number of associated image strips 3, such that the width of said visible image strips 10b is a multiple of the width 1 of the image strips 3. By way of nonlimiting example, a device according to the invention was produced with p=1.6 mm, d=1.6 mm and l=0.8 mm. In the embodiment of FIG. 3b, the width of the visible strips 10b is 5 mm and the pitch of the array of strips is 9 mm.

By keeping the same angle of inclination α of 10° but by this time modifying the angle of observation θ so that it is 40° (FIG. 3c), the form of the visible array 12c remains identical to the array 12b, but is shifted in space. In effect, all of the positions of the visible image strips 10b observed from an angle θ of 30° (FIG. 3b) correspond to those of the visible sensor strips 11c from an angle θ of 40° (FIG. 3c). This apparent shift is periodic over observation ranges of 40°.

These three embodiments show that, by acting on the nature of the arrays of image zones and of visible zones of the sensor, and on the angle of observation of the device by an observer, the latter can have the illusion of a variability of the visible image zones 10 and of the visible zones of the sensor 11 while, at the same time, the surface area proportions of said zones (10, 11) remain constant. This variability relates to the form, the brightness and the absolute positions of said visible image zones 10 and of said visible zones of the sensor 11 in the reference frame of the observer in motion. Advantageous configurations will be considered such that there is little variability of the image observed in the reference frame of the observer in motion. For total surface areas of image strips 3 identical to the total surface area of the transparency strips 4, a small variability is observed when the angle of inclination α lies between 35° and 70°. It should be noted that if the solar sensor were to be replaced by a device of the same appearance but without the function of energy production, the same variability of appearance of the visible image zones 10 (and therefore the same visual integration) would be retained, but without energy production by the device. The device according to the invention therefore makes it possible to improve the visual integration of the light energy sensors 5 on supports, independently of their angular ranges of observation, and regardless of the orientation of the device in relation to the light source. Moreover, the method for producing such a device does not require very accurate setting between the image zones 3 and the transparent plate 1, the appearance of the device not changing significantly when the angle of inclination α varies by a few degrees.

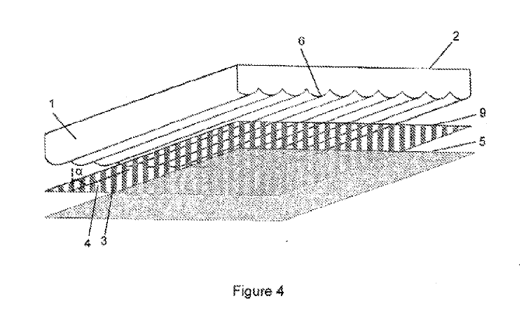

According to an additional variant embodiment illustrated in FIG. 4, the device consists of an array of image strips 3 printed on a transparent support 9 placed between an optically structured transparent plate 1 and a light energy sensor 5. Unlike the embodiment schematically represented in FIG. 2a, the front face 2 of said transparent plate 1 is planer whereas the rear face 6 is composed of an array of cylindrical rectilinear lenses. The longitudinal axis of the image strips 3 is inclined by a non-zero angle α in relation to the longitudinal axis of the lenses.

Such a device has a number of advantages. The flatness of the front face 2 avoids the fouling of the lenses and simplifies the cleaning of the outer surface of the device without it being necessary to add an additional plate which would increase the thickness and the cost of the device. At the same time, this surface gives the feel a smooth aspect for the user, which is advantageous in many applications, for example a portable telephone shell. This aspect can be modulated by a micro-structuring of the front face 2, so as to extend the range of feels. Finally, the printing of the image strips 3 on a support 9 which is not glued to the adjacent elements of the device makes it possible to change the appearance of the image strips 3, for example their forms or their colors, at lesser cost by replacing only the support 9 and not the plate 1.

FIG. 5a schematically shows the two devices 14 and 15 defined respectively in FIGS. 1a and 2a, provided with photovoltaic sensors 5 which are illuminated by a light source 16, the trajectory of which is imposed in the plane (OXZ).

FIG. 5b presents, on one and the same graph, the two curves of electrical production of the photovoltaic sensors 5 as a function of the angle of incidence β of the light, for the device known from the prior art 14 (continuous line) and for the device that is the subject of the invention 15 (dotted line). Interest is focused on the variation of the electrical production as a function of the angle of incidence β, which is why the production values are normed. It can then be observed that the electrical production varies up to close to 80% in relation to the peak-to-peak average value for the device 14, the minimum and maximum productions alternating approximately every 30°. The minimum production corresponds to the illumination by the light source 16 of all of the image strips 3, a configuration in which the photovoltaic sensor 5 receives only a small quantity of light and therefore produces little. For its part, the maximum production corresponds to the illumination of a multitude of zones of the photovoltaic sensor 5 through the transparency strips 4, said sensor 5 consequently receiving a strong light intensity. By comparison, the device 15 exhibits a small variation of the energy production, which does not exceed 12% in relation to the average value between the maximum production and the minimum production. In the device that is the subject of the invention 15, the electrical production is therefore substantially constant as a function of the angle of incidence β and of the external light 16.

### ADVANTAGES OF THE INVENTION

The result of the above is that the invention achieves the aims set. It describes a device having optical characteristics to give the illusion of relief to an image placed on the surface of a light energy sensor, without presenting the drawbacks of the hitherto known devices.

The device that is the subject of the invention will make it possible to improve the visual integration, in particular, of the light energy sensors, or of other elements of similar appearance, independently of the angular ranges of observation of the device, and to simplify the method for fabricating such a device.

In the case of the use of light energy sensors, this aesthetic advantage is obtained while keeping the energy production of said sensor substantially constant regardless of the angle of incidence of said external light on the device.

The invention is particularly suited to the visual integration of solar sensors on the back of screens of display devices such as portable computers and advertizing panels, on shells of cell phones, watches, toys, computer keyboards, blinds, sunshades, shade screens, parasols, shading structures, roofs, walls, tiles, transport vehicles, including boats and aeroplanes, clothing, backpacks and, generally, on any imaged support, including electronic images, and on any planer or curved surfaces.

1. A device comprising at least
(a) a sensor of light energy originating from an external light source;
(b) a transparent plate arranged between said external light source and said sensor, comprising a first face called “front face”which is oriented toward said external light source and a second face called “rear face”which is oriented toward said sensor, said transparent plate being structured optically on one of its two faces at least by a plurality of rectilinear and mutually parallel optical elements; and
(c) a plurality of image strips separated by transparency strips; wherein
the longitudinal axis of the image strips is inclined by a non-zero angle (α) relative to the longitudinal axis of the optical elements of the transparent plate, such that said images seen through the transparent plate appear with a relief effect, while the energy production of the sensor remains substantially constant whatever the angle of incidence of said external light on the device.

2. The device as claimed in claim 1, wherein the total surface area of the image strips is substantially identical to the total surface area of the transparency strips.

3. The device as claimed in claim 1, wherein the angle of inclination (α) between the longitudinal axis of the lenses and the longitudinal axis of the image strips lies between 35° and 70°, such that the appearance of said images remains substantially constant as a function of the angle of observation (θ) of the device.

4. The device as claimed in claim 1, wherein said image strips are fixed or animated, and comprise a multitude of opaque, reflecting or semi-transparent pixels, printed or generated electronically by backlit, light-emitting, or reflecting components.

5. The device as claimed in claim 1, wherein said image strips are positioned between the sensor and the rear face of the transparent plate, or downstream of said sensor, relative to the direction of propagation of the light from the external light source toward the device.

6. The device as claimed in claim 1, wherein said image strips are in contact with said sensor and/or said rear face of the transparent plate, or separated from these surfaces by a material of refractive index different from that of the transparent plate.

7. The device as claimed in claim 1, wherein said light energy sensor is a solar sensor of thermal, photovoltaic, chemical or hybrid type, planer or curved, rigid or flexible.

8. The device as claimed in claim 1, wherein the light energy sensor is composed of solid or semi-transparent active zones, adjacent or separated from one another by zones of transparency.

9. The device as claimed in claim 1, wherein the optical elements of the transparent plate are at least one of:
(a) convex or concave lenses, symmetrical or asymmetrical; and
(b) prisms.

10. The device as claimed in claim 1, wherein the transparent plate, the image strips and the sensor are contained in planes that are mutually parallel but that can undergo a deformation such that these planer surfaces become curved surface.

11. The device as claimed in claim 1, wherein the optical elements of the transparent plate and the image strips are organized in arrays of basic structures.

12. The device as claimed in claim 1, wherein the transparent plate and the image strips are fixed relative to the sensor.

13. The device as claimed in claim 1, wherein the transparent plate and the image strips are mobile relative to the sensor, by undergoing, translational and/or rotational movements.

14. The device as claimed in claim 1, wherein the transparent plate comprises a solid, liquid or gaseous transparent material, such as glass or a polymer of PMMA, PET or polycarbonate type, and is planer or curved, rigid or flexible, colored in its mass or colorless.

15. The device as claimed in claim 1, wherein one of the two faces of said transparent plate at least is covered by a functional surface, comprising one of antiglare, anti-fouling or anti-UV.

16. The device as claimed in claim 1, wherein the image strips are illuminated by one or more sources of lighting from which light is propagated in the thickness of the transparent plate which acts as waveguide, or in an additional transparent plate placed upstream or downstream of the transparent plate relative to the direction of propagation of the light from the source of lighting toward the device.

17. The device as claimed in claim 1, wherein the light energy sensor is a photovoltaic sensor provided with electron-collecting gratings on the surface of said sensor, and wherein a part of the surface of said image strips comprises the visible face of the electron-collecting gratings.

18. The device as claimed in claim 1, wherein the sensor is replaced by a non-functional support, of the same dark appearance as a light energy sensor.
